(19) United States
(12) Patent Application Publication
(10) Pub. No.: US 2015/0003600 A1
(43) Pub. Date: Jan. 1, 2015

(54) SYSTEMS AND METHODS FOR BLOCKING UNDESIRED AUTOMATED TELEPHONE CALLS

(71) Applicant: VONAGE NETWORK, LLC, Holmdel, NJ (US)

(72) Inventor: Andrew BUCKO, Old Bridge, NJ (US)

(21) Appl. No.: 13/931,261

(22) Filed: Jun. 28, 2013

(51) Int. Cl. H04M 3/436; H04M 3/42

(52) U.S. Cl. CPC H04M 3/436; H04M 3/42059
USPC 379/210.02

(57) ABSTRACT

Systems and methods for identifying and blocking undesired automated calls include checking to determine if more than a predetermined number of calls are received from the same originating telephone number within a certain period of time. If so, information about the calls from the same originating telephone number is analyzed to determine if the calls conform to one or more patterns that indicate the calls are likely undesired automated calls. If so, further calls from the originating telephone number may be blocked.

### BACKGROUND OF THE INVENTION

The invention is related to telephony systems. More specifically, the invention is related to systems and methods for blocking undesired automated calls, which are also known as “robocalls.”

An automated calling system allows an operator to record an audio message that is to be delivered to multiple parties. The operator then provides a list of telephone numbers to the automated calling system. The automated calling system places calls to each of the numbers, and when a called party answers, the pre-recorded audio message is played to the called party. In some instances, automated calling systems are sophisticated enough to recognize when an answering machine or an automated voice mail service answers such a call. In that case, the automated calling system waits until the voice mail service asks the calling party to leave a message, at which point the automated calling system begins to play the pre-recorded audio message.

Some of the most popular uses for automated calling systems are the delivery of marketing messages, and the delivery of messages from political candidates or political action committees. Many people view such messages as undesirable.

However, there are also valuable uses for automated calling systems, such as the delivery of public safety messages. For example, such automated calling systems can deliver audio recordings to parents to inform them of an unexpected school closing. Such automated calling systems can also deliver public safety messages on a variety of topics to people within a defined geographical area.

It is possible for the operators of telephony systems to design systems and methods to quickly block all automated calls that are being sent from a single originating telephone number. This prevents the users of the telephony system from being bothered by undesired automated calls. However, if all automated calls are blocked from reaching the users, the desirable automated calls will be blocked along with the undesired automated calls.

There is a need for systems and methods which can effectively distinguish between those automated calls which users would likely wish to receive, and those automated calls that users would likely not wish to receive. Once the undesired automated calls are identified, the undesired automated calls could be blocked, and the desirable automated calls could be allowed to complete to the users.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 is a diagram of various elements of a processor that forms part of an IP telephony system or an IP telephony device according to an embodiment of the invention;

FIG. 3 is block diagram illustrating various elements of an IP telephony system according to an embodiment of the invention;

FIG. 4 is a flowchart illustrating steps of a first method of blocking undesired automated calls; and

FIG. 5 is a flowchart illustrating steps of a second method of blocking undesired automated calls.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

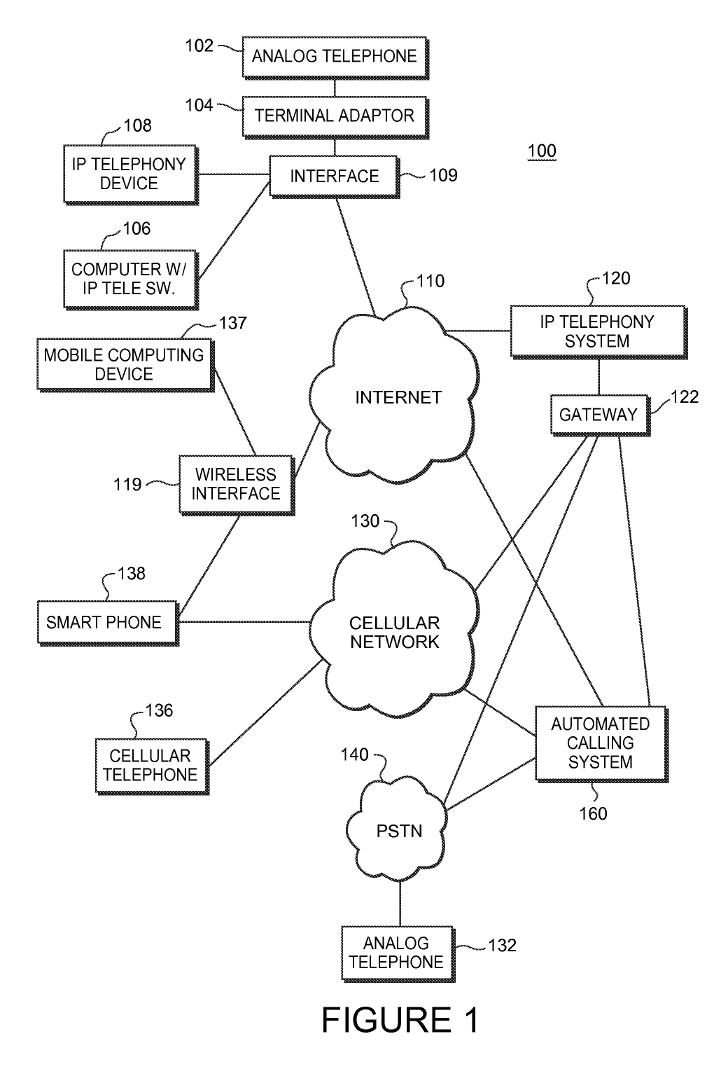

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection. In some instances, the IP telephone 108 could utilize a data channel provided by a cellular telephone system 130 to access the Internet 110.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software could also be used to place and receive telephone calls through the IP telephony system 120. The mobile computing device 137 accesses the Internet 110 via a wireless data network interface 119. The wireless data network interface 119 could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 130 or cellular network 130.

FIG. 1 also illustrates that an automated calling system 160 is connected to the PSTN 140, the cellular network 130 and the Internet 110. The automated calling system 160 may also be connected to the IP telephony system 120 via the gateway 122. The automated calling system 160 is designed to place calls to telephony devices in an automated fashion, and to play audio recordings to the called parties. As mentioned above, in some instances, the automated calling system 160 may be sophisticated enough to recognize when an answering machine or an automated voice mail service answers such a call. In that case, the automated calling system 160 waits until the voice mail service asks the calling party to leave a message, at which point the automated calling system 160 begins to play the pre-recorded audio message.

When the automated calling system 160 places calls to users of the IP telephony system 120, the calls may initially be routed through the Internet 110 to the IP telephony system 120. The IP telephony system 120 then acts to connect the incoming call to one of its users. In other instances, the automated calling system may first deliver an automated call to the PSTN 140 or the cellular network 130. The PSTN 140 or cellular network 130 then delivers the call to the IP telephony system 120, and the IP telephony system 120 then acts to connect the incoming call to one of its users. In still other instances, the automated calling system 160 may be directly connected to the IP telephony system 120 via a gateway 122. Regardless of how an automated call from the automated calling system 160 is connected to the IP telephony system 120, the IP telephony system 120 initially receives the automated call, and acts to connect the automated call to one of its user's telephony devices.

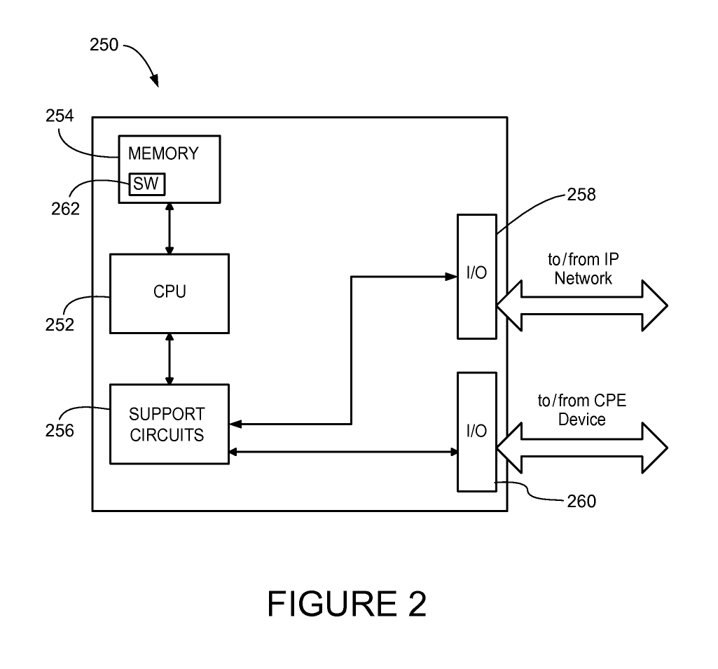

FIG. 2 illustrates elements of a computer processor 250 that can be used as part of the IP telephony system 120 or a telephony device to accomplish various functions. The IP telephony system 120 could include multiple processors 250 located at various locations in the system, along with their operating components and programming, each carrying out a specific or dedicated portion of the functions performed by the IP telephony system 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod touch™, which includes a speaker and a microphone. A software application loaded onto an Apple iPod touch™ can be run so that the Apple iPod touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

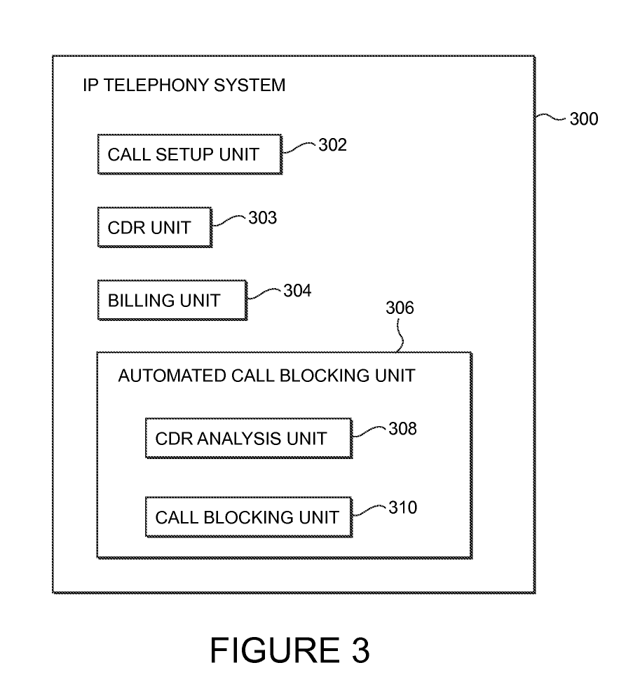

FIG. 3 illustrates selected elements of an IP telephony system 300 according to one embodiment of the invention. The IP telephony system 300 includes a call setup unit 302 that is responsible for setting up calls to or from a user's telephony device. This includes incoming calls that are to be connected to user telephony devices, and outgoing calls that originate at one of the users' telephony devices, and which are to be routed to either another user's telephony device, or to a telephony device that is reachable via the PSTN 140 or the cellular network 130.

The IP telephony system 300 also includes a CDR unit 303 which stores information about telephony communications that are handled by the IP telephony system 130. A billing unit 304 uses the information in the CDR unit 302 to bill for the communications handled by the IP telephony system 300.

The IP telephony system also includes an automated call blocking unit 306. The automated call blocking unit 306 includes a CDR analysis unit 308, and a call blocking unit 310. The CDR analysis unit 308 reviews information in CDRs stored in the CDR unit 303 to attempt to identify a series of automated calls that are being placed to users of the IP telephony system 300. When such automated calls are identified, the CDR analysis unit 308 also attempts to determine if the automated calls are likely undesired automated calls. If so, the call blocking unit 310 acts to block further automated calls from the same source for at least a predetermined period of time. Details of how the elements of the automated call blocking unit 306 operate to identify and block undesired automated calls are discussed below.

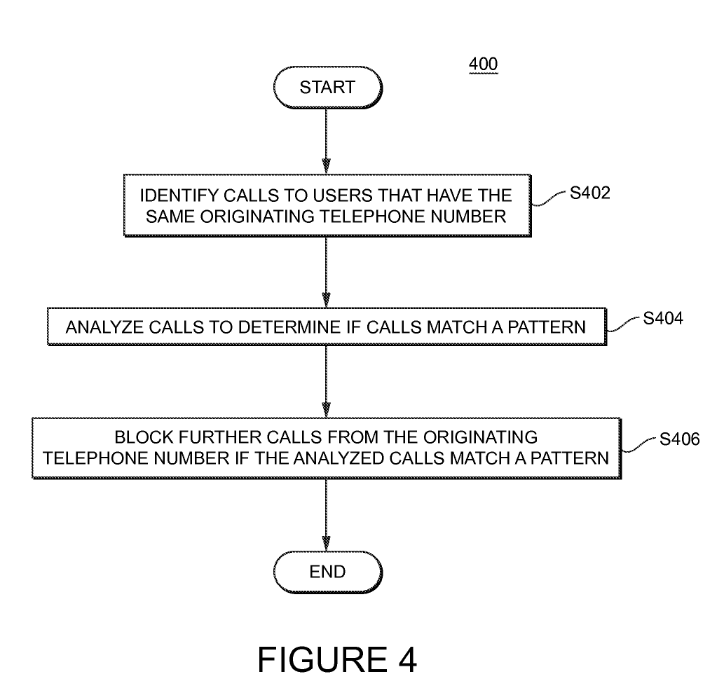

FIG. 4 illustrates steps of a first method 400 of identifying and blocking undesired automated calls. Details of this method are explained with references to the IP telephony system 300 illustrated in FIG. 3, and the overall communications environment illustrated in FIG. 1.

The method 400 begins and proceeds to step S402, where the CDR analysis unit 308 of an automated call blocking unit 306 of an IP telephony system reviews records of incoming calls to determine if multiple incoming calls from the same originating telephone number have been directed to multiple users of the IP telephony system within a relatively short time period. If so, this likely indicates that an automated calling system 160 is sending automated calls to the users of the IP telephony system.

The analysis performed in step S402 could include reviewing the call detail records for all incoming calls received by the IP telephony system within a predetermined time window. The analysis looks for significant numbers of such calls all having the same originating telephone number. This step could include determining if the number of calls to all users of telephony system which have the same originating telephone number is above a first threshold value. If so, a determination is made that the calls received from the originating telephone number are likely from an automated calling system.

If the result of the analysis performed in step S402 indicates that an automated calling system appears to be sending automated calls to the users of the IP telephony system, then in step S404 the CDR analysis unit 308 of the automated call blocking unit 306 analyses the calls that are all from the same originating telephone number to determine if they conform to one or more patterns. If the calls from the same originating telephone number conform to a first pattern, that may indicate that the calls are likely undesired automated calls. If the calls from the same originating telephone number conform to a second pattern, that may indicate that the calls are likely desirable automated calls.

For example, in step S404 the CDR analysis unit 308 may examine information about the calls received from the same originating telephone number to determine the average duration of the calls. If the average duration of the calls is only a few seconds, for example 10 to 20 seconds, this would appear to indicate that the called parties quickly hang up after listening to only a short part of an audio message. This would tend to indicate that the calls are from an automated calling system, and that the audio message contained in the automated calls is not of interest to the majority of called parties. In other words, the automated calls are undesired automated calls. This would often be the case where the audio message is a product or service advertisement, or a political message.

On the other hand, if the analysis indicates that the average duration of the calls from the same originating telephone number is considerably longer, such a one minute or longer, this would likely indicate that the calls are from an automated calling system, but that the audio message being delivered via the automated calls is of interest to the called parties.

In other instances, the analysis performed in step S404 could include determining if more than a certain percentage of the calls from the same originating number have a call duration that is shorter than a threshold duration. For example, if 95% of the calls from the same originating telephone number have a duration of less than 20 seconds, this would again tend to indicate that the calls are undesired automated calls. And the fact that the remaining 5% of the calls have a longer duration would not impact that judgment. Analyzing the calls in this fashion, may give more accurate results than simply looking at the average duration for all calls from the same originating telephone number.

The analysis performed in step S404 may also include checking to determine how the calls from the same originating telephone number are terminated. If the majority of the calls are terminated by the called party within a short period of time after the calls begin, this would also tend to indicate that the calls from the same originating telephone number are undesired automated calls. On the other hand, if the majority of the calls from the same originating telephone number are terminated by the calling party within a relatively short period of time after the calls begin, this could indicate that the automated calls are delivering an interesting but short audio message, which the called parties listen to in its entirety. This would tend to indicate that the calls are desired automated calls.

The analysis performed in step S404 could include checking to determine if the calls from the same originating telephone number are being placed to substantially consecutive telephone numbers. If so, this would tend to indicate that the calls are automated calls being placed by an automated calling system 160 using simple lists of consecutive telephone numbers. Although this information alone would not necessarily determine if the automated calls are desirable or undesirable, this fact would help to confirm that the calls are originating from an automated calling system.

The analysis performed in step S404 may also include determining if the calls from the same originating telephone number are being directed to users located in the same geographical area. This information could help to confirm that the calls are automated calls, because many automated calls are intended to focus on users in defined geographical area. For example, one would expect automated calls with a message about a particular political candidate to focus on users in the geographical area qualified to vote for or against that candidate. Here again, this information alone would not necessarily determine if the automated calls are desirable or undesirable. But this fact would help to confirm that the calls are originating from an automated calling system.

Another pattern to note would be if the individuals receiving calls from a particular originating telephone number place a return call to that originating telephone number, or to another particular telephone number. This could occur where the calls from a particular originating telephone number result in messages being left for the called individuals, and where the messages induced the called parties to place a return call, or a call to another specific telephone number. The length of such return calls may also provide an indication of whether the calls from the originating telephone number were desired. If the calls were generally undesired, one would expect the return calls to be short in duration.

Another concept which may be useful in identifying automated calls is the telephone numbers and the order in which a series of calls from an originating telephone number are placed. For example, if an automated calling system uses a list of telephone numbers to place a first series of automated calls, one could note the specific order in which the telephone numbers were called. If the same party later uses the same list of telephone numbers to place a second series of automated calls from a different originating telephone number, it may be possible to quickly identify the second series of calls as coming from the same automated calling system. If one notes that the second series of telephone calls are being placed to the same telephone numbers, in the same order, as the first series of calls, one could determine that the same automated calling system is using the same list of telephone number to place a new series of automated telephone calls. And once this determination is made, the second series of automated calls could be blocked.

In step S406, the automated calls are blocked if they conform to a particular pattern or patterns that indicate that the calls are undesired automated calls, as explained above. The above examples are not intended to be exhaustive. Information about calls coming from the same originating telephone number could be examined to determine if the calls conform to other patterns in an effort to determine if the calls are likely undesired or desired automated calls.

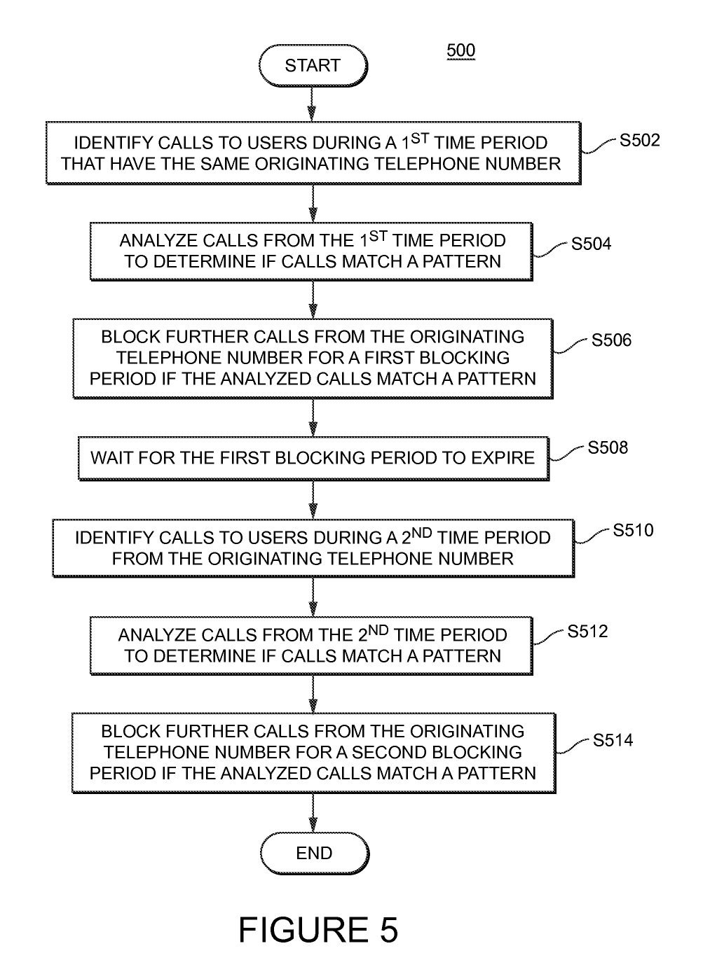

In some instances, step S406 could involve blocking all further calls from the same originating telephone number. In alternate embodiments, calls from the originating telephone number may only be blocked for a predetermined period of time. After that time expires, calls from the originating telephone number could again be allowed to complete to users of the telephony system, and a new analysis of any such calls is performed to determine if further calls should be blocked. Such a method is described below with references to FIG. 5.

The method 500 begins and proceeds to step S502, where records of calls to users of a telephony system that occur within a first time period are examined to determine if more than a first threshold number of the calls came from the same originating telephone number. If so, in step S504, the calls from the same originating telephone number are analyzed to determine if the calls match one or more patterns that indicate the calls are likely undesired automated calls. If so, in step S506, a call blocking unit 310 blocks further calls from the originating telephone number for a first blocking period.

In step S508, the first blocking period is allowed to expire. After the first blocking period expires, further calls from the same originating telephone number are allowed to complete to the users of the telephony system.

The method then proceeds to step S510, where records of calls to users of the telephony system that occur during a second time period, which occurs after the first blocking period has expired, are examined to determine if more than a second threshold number of calls came from the same originating telephone number. The second threshold number of calls could be lower than the first threshold number of calls that was used in step S502, in recognition of the fact that the originating telephone number has already been identified as one used by an automated calling system. If more than the second threshold number of calls were from the originating telephone number, then in step S512 the calls from the originating telephone number occurring during the second time period are analyzed to determine if they also correspond to one or more patterns indicative of undesired automated calls. If so, in step S514 further calls from the originating telephone number are blocked for a second blocking period. The second blocking period could be longer than the first blocking period.

A method as illustrated in FIG. 5 allows a telephony system to act more quickly to block undesired automated calls if the same originating telephone number has been used in the past to send undesired automated calls. The second time an analysis is performed, the period of time during which call information is collected can be shorter, and the threshold number of calls that triggers a more in depth analysis may be smaller. Also, if the same originating telephone number is again sending undesired automated calls, the second blocking period could be longer, or made permanent.

In alternate embodiments of the above methods, once a series of calls from the same originating telephone number have been identified, the analysis performed in step S404 of the method in FIG. 4 or steps S504 and S512 of the method illustrated in FIG. 5 may include diverting one or more calls from the originating telephone number to a customer service representative of the telephony system. The customer service representative could then listen to one or more of the calls coming from the originating telephone number to help determine if the calls are undesired or desired automated calls.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of handling automated calls, comprising:
determining if more than a first threshold number of calls have been placed to multiple users of a telephony system from an originating telephone number within a first predetermined time window;
checking, if the determining step is positive, whether calls from the originating telephone number conform to a pattern; and
blocking further calls from the originating telephone number to one or more users of the telephony system based on the result of the checking step.

2. The method of claim 1, wherein the checking step comprises determining whether the average duration of calls from the originating telephone number is shorter than a threshold duration.

3. The method of claim 1, wherein the checking step comprises determining whether more than a predetermined percentage of calls from the originating telephone number have a duration that is shorter than a threshold duration.

4. The method of claim 1, wherein the checking step comprises determining whether more than a predetermined percentage of calls from the originating telephone number are terminated because the called party terminated the call within a predetermined period of time after answering.

5. The method of claim 1, wherein the checking step comprises determining if calls from the originating telephone number are being placed to consecutive telephone numbers.

6. The method of claim 1, wherein the determining step comprises determining if more than a first threshold number of calls have been placed to users of a telephony system that are located in a particular geographical area from the originating telephone number within the first predetermined time window.

7. The method of claim 1, wherein the blocking step comprises blocking further calls from the originating telephone number to the one or more users of the telephony system for a first blocking period.

8. The method of claim 7, wherein if further calls from the originating telephone number are blocked for a first blocking period, the method further comprises:
determining, after the first blocking period has expired, if more than a second threshold number of calls have been placed to the users of the telephony system from the originating telephone number within a second predetermined time window;
checking, if the determining step is positive, whether calls from the originating telephone number placed during the second predetermined time window conform to a pattern; and
blocking further calls from the originating telephone number to the one of more users of the telephony system for a second blocking period if the checking step indicates that calls from the originating telephone number placed during the second predetermined time period conform to a pattern.

9. The method of claim 8, wherein the second threshold number of calls is smaller than the first threshold number of calls.

10. The method of claim 8, wherein the second blocking period is longer than the first blocking period.

11. The method of claim 1, further comprising diverting at least one incoming call from the originating telephone number to a customer service representative of the telephony system.

12. The method of claim 11, wherein the blocking step is only performed if a signal is received from the customer service representative that indicates that calls from the originating telephone number should be blocked.

13. A system for handling automated calls, comprising:
means for determining if more than a first threshold number of calls have been placed to multiple users of a telephony system from an originating telephone number within a first predetermined time window;
means for checking, if the determining step is positive, whether calls from the originating telephone number conform to a pattern; and
means for blocking further calls from the originating telephone number to one or more users of the telephony system based on the result of the checking step.

14. A system for handling automated calls, comprising:
a CDR analysis unit that determines if more than a first threshold number of calls have been placed to multiple users of a telephony system from an originating telephone number within a first predetermined time window, and that determines whether calls from the originating telephone number conform to a pattern; and
a call blocking unit that blocks further calls from the originating telephone number to one or more users of the telephony system based on input from the CDR analysis unit.

15. The system of claim 14, wherein the CDR analysis unit determines whether the average duration of calls from the originating telephone number is shorter than a threshold duration.

16. The system of claim 14, wherein the CDR analysis unit determines whether more than a predetermined percentage of calls from the originating telephone number have a duration that is shorter than a threshold duration.

17. The system of claim 14, wherein the CDR analysis unit determines whether more than a predetermined percentage of calls from the originating telephone number are terminated because the called party terminated the call within a predetermined period of time after answering.

18. The system of claim 14, wherein the CDR analysis unit determines if calls from the originating telephone number are being placed to consecutive telephone numbers.

19. The system of claim 14, wherein CDR analysis unit determines if more than a first threshold number of calls have been placed to users of a telephony system that are located in a particular geographical area from the originating telephone number within the first predetermined time window.

20. The system of claim 14, wherein the call blocking unit blocks further calls from the originating telephone number to the one or more users of the telephony system for a first blocking period.

21. The system of claim 20, wherein after the call blocking unit has blocked calls from the originating telephone number for the first blocking period, the CDR analysis unit thereafter determines if more than a second threshold number of calls have been placed to the users of the telephony system from the originating telephone number within a second predetermined time window, and also determines whether calls from the originating telephone number placed during the second predetermined time window conform to a pattern, and wherein the call blocking unit blocks further calls from the originating telephone number to the one or more users of the telephony system for a second blocking period if the CDR analysis unit determines that calls from the originating telephone number placed during the second predetermined time period conformed to a pattern.

22. The system of claim 21, wherein the second threshold number of calls is smaller than the first threshold number of calls.

23. The system of claim 21, wherein the second blocking period is longer than the first blocking period.

24. The system of claim 14, wherein the call blocking unit diverts at least one incoming call from the originating telephone number to a customer service representative of the telephony system.

25. The system of claim 24, wherein the call blocking unit blocks calls from the originating telephone number only if a signal is received from the customer service representative that indicates that calls from the originating telephone number should be blocked.

26. The method of claim 1, further comprising:
determining that automated calls are being placed from the originating telephone number if more than the first threshold number of calls have been placed to the multiple users of the telephony system from the originating telephone number within the first predetermined time window; and
checking, if the determining step is positive, whether the calls from the originating telephone number conform to a pattern indicative of the automated calls.

27. The system of claim 13, wherein the CDR analysis unit determines that automated calls are being placed from the originating telephone number if more than the first threshold number of calls have been placed to the multiple users of the telephony system from the originating telephone number within the first predetermined time window, and wherein the CDR analysis unit determines whether calls from the originating telephone number conform to a pattern indicative of the automated calls.
